(19) United States
(12) Patent Application Publication
(10) Pub. No.: US 2008/0124059 A1
(43) Pub. Date: May 29, 2008

(54) Constant voltage power supply circuit, constant voltage supplying method, and portable constant voltage power supply device, electric reel, fishing rod supporting tool, and fishing rod holding device that use the same constant voltage power supply circuit

(75) Inventor: Kiyoshi Okishima, Tokyo (JP)

Correspondence Address: GREER, BURNS & CRAIN, 300 S WACKER DR, 25TH FLOOR, CHICAGO, IL, 60606, US

(73) Assignee: c/o Sanyo Tecnica Co., Ltd., Tokyo (JP)

(21) Appl. No.: 11/985,539

(22) Filed: Nov. 15, 2007

(30) Foreign Application Priority Data
Nov. 29, 2006 (JP) 2006-321539
Apr. 24, 2007 (JP) 2007-113697

(51) Int. Cl. H02P 5/00; G05F 1/10; A01K 97/10; B65H 75/00; H05B 41/16

(52) U.S. Cl. 388/800; 323/274; 315/246; 242/390.8; 43/21.2

(57) ABSTRACT

A constant voltage power supply circuit includes oscillation means; a step-up or step-down circuit including coil means and capacitive means; detecting means that detects an outputted voltage value of the step-up or step-down circuit, and compares the detected value with a predetermined reference value to output a detected information, at which either the detected value exceeds the reference value or becomes lower than the reference value; and control means that controls, based on the detected information of the detecting means, supply of the pulse signals outputted from the oscillation means to the step-up or step-down circuit.

### BACKGROUND OF THE INVENTION

1. Field of the Invention

The present invention relates to constant voltage power supply circuits, and more particularly, to a constant voltage power supply circuit with a simple circuit configuration that can be easily controlled with high efficiency, less heat generation, and at low cost. The present invention further relates to a constant voltage power supply device, fishing tool, and such that employ the constant voltage power supply circuit.

2. Description of Related Art

Conventionally, various power supply circuits have been provided as a power supply for an electrical or electronic device driven by electrical energy. Many proposals have also been made in an attempt to make such a power supply circuit with constant voltage.

Typically, such a power supply circuit with constant voltage often uses a so-called step-up circuit or a step-down circuit constituted by a coil, a capacitor, and switching means, for example. In most cases, a pulse width modulation (PWM) method is employed in order to adjust voltage in this type of circuit.

For example, NJM2360 and NJM2374 manufactured by New Japan Radio Co., Ltd. are known as the converter Ics for a step-up circuit or a step-down circuit using a PWM circuit. Because such a known general-purpose IC uses a PWM circuit, a pulse width varies and a noise frequency varies along with voltage control at a subsequent stage, which often causes noise in a wide range, even though an oscillating frequency is fixed. As a result, it is difficult to remove the noise and the cost increases.

Specifically, in the control of voltage when the above described PWM circuit is used, variation in voltage or current outputted from the step-up circuit or the step-down circuit is detected, and a pulse width of a pulse outputted based on the detected information varies. Consequently, an oscillating frequency is also constantly changes. Therefore, the control becomes complex, conversion efficiency also varies and is not constant, it is impossible to increase conversion efficiency to a maximum level, and the circuit becomes complex to increase the cost. In addition, a ripple occurs frequently leading a frequent occurrence of noise, and heat generation from the step-up or step-down circuit increases because a control operation is frequently performed. Accordingly, cooling means for the circuit is necessary. In addition, it is not possible to freely drive an LED light source which is susceptible to heat, and a conventional output of the LED light source is up to 2 W in the way it is now.

As a constant voltage power supply circuit for maintaining voltage at a constant level using a step-up switching circuit as described above, Japanese Patent Application Laid-Open (KOKAI) No. 2006-148987, Japanese Patent Application Laid-Open (KOKAI) No. 2006-49423, and Japanese Patent Publication (KOKOKU) No. H07-34650, and such are known, for example. Any of these patent publications employs a step-up process or a step-down process using the PWM circuit as given, in combination with pulse signals of a frequency fixed at an early stage of the control. Thus, these patent publications include all of the problems of the conventional art as described above.

### SUMMARY OF THE INVENTION

In view of the above problem, an object of the present invention is to address to the conventional problems, and to provide a constant voltage power supply circuit, with which noise can be easily removed, having a simple configuration, high conversion efficiency, a wide control range, and low heat generation, and at low cost. Further, the present invention aims to provide constant voltage power supply devices using the constant voltage power supply circuit and various electrical equipment products using the constant voltage power supply circuit.

In order to achieve the above objects, the constant voltage power supply circuit according to the present invention adopts basic technical configurations as described below.

Specifically, an aspect of the present invention is a constant voltage power supply circuit, comprising: oscillation means for generating pulse signals having a predetermined specific frequency; a step-up or step-down circuit including at least coil means and capacitive means; detection means for detecting an output voltage value of the step-up or step-down circuit, comparing the output voltage value with a predetermined reference value, and outputting a detected information when the output voltage value exceeds the reference value or becomes lower than the reference value; and control means for controlling, based on the detected information from the detection means, a supply of the pulse signals outputted from the oscillation means to the step-up or step-down circuit, wherein the control means is configured to prevent the pulse signals from being supplied to the step-up or step-down circuit based on the detected information outputted from the detection means, thereby the control means intermitting the pulse signals outputted from the oscillation means.

The constant voltage power supply circuit according to the present invention adopts the above stated technical configuration, and consequently a constant voltage power supply circuit, with which noise can be easily removed, having a simple configuration, high conversion efficiency, a wide control range, and low heat generation, and at low cost can be realized.

To further illustrate in detail, in the constant voltage power supply circuit according to the present invention, a frequency of a switching pulse is fixed to a constant value, and the frequency is set to remain constant and not vary. Therefore, as the removal of noise is relatively easy, a filter configuration is simple, and the circuit configuration becomes simpler. In addition, the constant voltage power supply circuit according to the present invention is high in energy conversion efficiency, and it is possible to realize the conversion efficiency over 90% in the present invention, in comparison with a conventional constant voltage power supply circuit in which the conversion efficiency is in the order of 70% at most.

Moreover, as a control range is relatively wide, the step-up or step-down circuit using the conventional PWM circuit as described above has a narrower control range of 20% to 30% at most. However, the present invention can provide the control range over 200%, and severity of the control is significantly reduced as compared to the conventional art.

Further, in the present invention, the cost can be greatly decreased because the circuit configuration is simple and the circuit can be made smaller. In addition, the conversion efficiency is high, the noise removal is easy, and an amount of the heat generation is small. Consequently a temperature of an entirety of the constant voltage power supply circuit does not increase greatly, and the present invention is suitable for a constant voltage power supply circuit for driving a light source using an LED that is susceptible to high temperature. While the conventional constant voltage power supply circuit is high in heat generation and the light source using an LED can be driven at 2 W at most, it is possible to drive the light source using an LED at 14 W, for example, by using the constant voltage power supply circuit according to the present invention.

Alternatively, the constant voltage power supply circuit according to the present invention can be effectively used as a power supply for a driving body such as a small sized high performance motor that is required to be drive at a stable current.

### BRIEF DESCRIPTION OF THE DRAWINGS

FIG. 1 is a block diagram showing a configuration of the present invention;

FIG. 2 is a circuit diagram showing an embodiment of a circuit configuration of a step-up circuit according to the present invention;

FIG. 3 is a graph showing an example of a constant voltage control method according to the present invention;

FIG. 4 is a circuit diagram showing a configuration of a first embodiment according to the present invention;

FIG. 5 is a circuit diagram showing a configuration of a second embodiment according to the present invention;

FIG. 6 is a diagram showing an example of a method for determining a specific and fixed frequency according to the present invention;

FIG. 7A and FIG. 7B are a drawing and a graph showing another embodiment according to the present invention, respectively;

FIG. 8A and FIG. 8B are drawings showing yet another embodiment according to the present invention;

FIG. 9 is a drawing showing a different embodiment according to the present invention; and

FIG. 10 is a drawing showing another different embodiment according to the present invention.

### DETAILED DESCRIPTION OF THE INVENTION

The following describes a configuration of an embodiment of a constant voltage power supply circuit 10 according to the present invention with reference to the drawings.

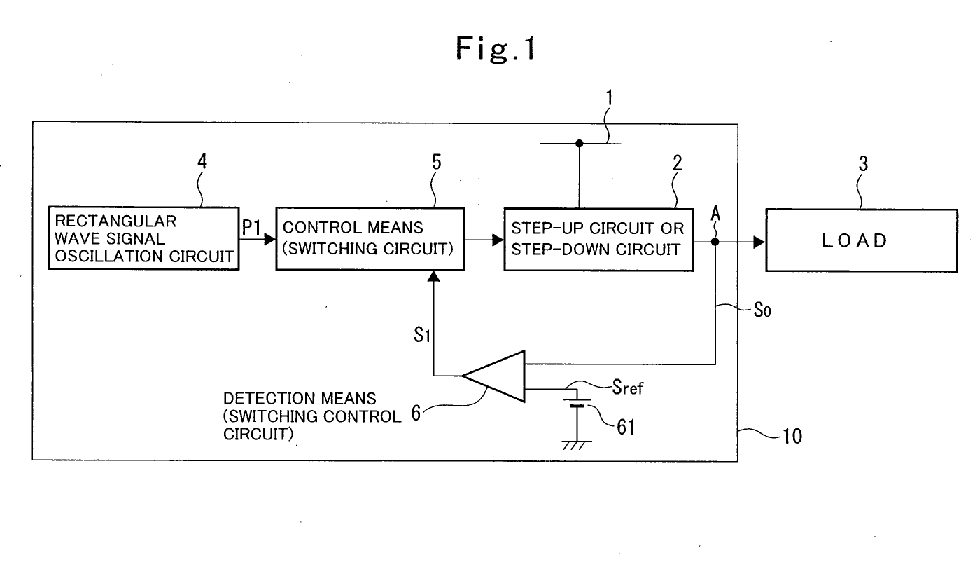

Specifically, FIG. 1 is a block diagram showing one embodiment of a configuration of the constant voltage power supply circuit 10 according to the present invention. The figure shows the constant voltage power supply circuit 10 constituted by: oscillation means 4 producing pulse signals P1 having a predetermined specific frequency; a step-up or step-down circuit 2 including at least coil means and capacitive means; a detecting means 6 that detects an outputted current value or an outputted voltage value S0 of the step-up or step-down circuit 2, and compares the detected value S0 with a predetermined reference value S_{ref} to output the detected information S1, at which either the detected value exceeds the reference value or becomes lower than the reference value; and control means 5 that controls, based on the detected information S1 of the detecting means 6, supply of the pulse signals P1 outputted from the oscillation means 4 to the step-up or step-down circuit 2. The control means 5 is configured to prevent the pulse signals P1 from being supplied to the step-up or step-down circuit 2 by intermitting the pulse signals P1 based on the detected information S1 outputted from the detecting means 6, with maintaining a frequency of the pulse signals P1 outputted from the oscillation means 4 constant.

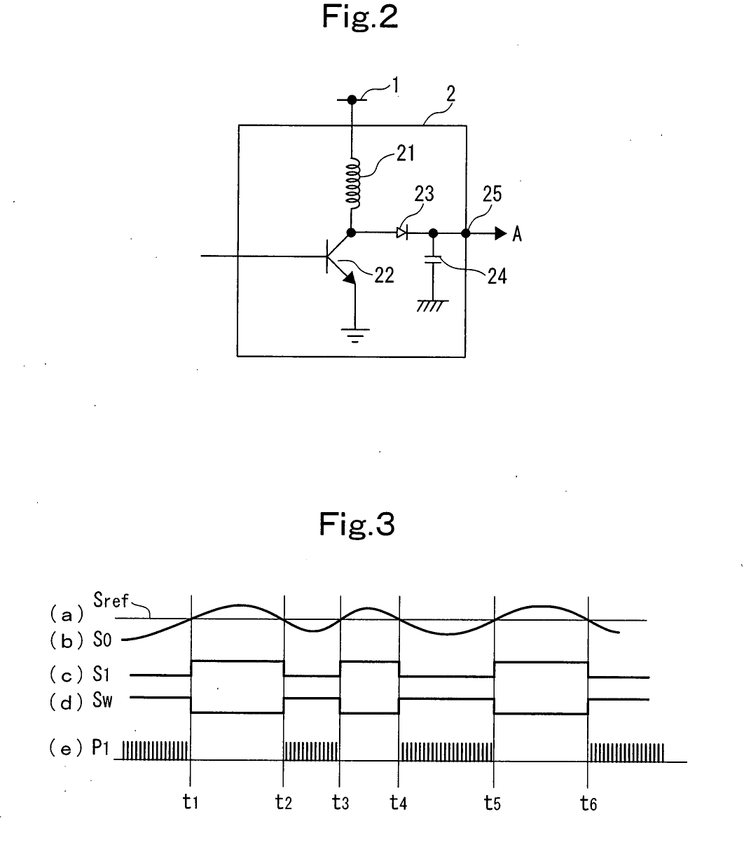

A configuration of the step-up circuit 2 used in the present invention is not particularly limited, and a step-up circuit that is conventionally known as shown in FIG. 2 can be used, for example.

Specifically, one example is shown as the step-up circuit 2 constituted by a coil 21 whose one end is connected to an appropriate power supply 1 and the other end is connected to a collector of a transistor 22, a rectifying diode 23 whose one end is connected to the other end of the coil 21 and the other end is connected to an output terminal 25 and one end of a capacitor 24, and the transistor 22 having a collector connected to the other end of the coil 21 and the one end of the rectifying diode 23, an emitter that is grounded and a base forming a control terminal.

The step-up or step-down circuit 2 according to the present invention can serve as a step-up circuit or a step-down circuit, depending on an aspect of use.

The oscillation means 4 used in the present invention can have any configuration as long as it is provided with an oscillation circuit producing rectangular wave pulses, and its specific configuration is not specifically defined. However, in the present invention, it is important that a frequency of the pulse signal generated from the oscillation circuit is designed to be set at a value equal to or close to the frequency which the coil 21 can perform with its maximum efficiency.

That is, a conventional voltage power supply circuit is not appropriate for driving a light source using a LED that is particularly vulnerable to a high temperature, and is not capable of driving under an optimal condition for the LED light source to emit light. This is because, as described above, the conventional constant voltage power supply circuit is designed based on a principal technical idea to use a PWM circuit. Because of this principal technical idea of the conventional constant voltage power supply circuit, cost increases because a control circuit is complex, a control method is also greatly complex because a frequency of pulse signals that are used and a duty ratio of each pulse constantly varies to cause frequent noise.

In addition, in the present condition, a control range is narrow, a control condition is severe, and efficiency is deteriorated. Further, heat generation from each circuit increases due to frequent operations, therefore, a temperature of an entirety of the constant voltage power supply circuit becomes high.

However, in the present invention, the step-up or step-down circuit 2 is driven by always using only pulse signals having a fixed frequency that exhibit maximum coil efficiency in the step-up or step-down circuit 2. As a result, the abovementioned problems of the conventional art can be entirely solved.

The rectangular wave pulse signals outputted from the oscillation means 4 according to the present invention are, as described above, set to a frequency with which the efficiency of the coil used in the step-up or step-down circuit can be exhibited maximally. Further, the pulse width of the pulse signal, that is, the duty ratio is preferably fixed to a value at which the maximum coil efficiency can be exhibited or a value in the vicinity of this value. Further, it is preferable that both of the frequency and the duty ratio are fixed specific values, respectively, or values in the vicinity of the specific values.

In the present invention, as described above, the frequency, or the pulse width or duty ratio of the pulse signals with which the maximum coil efficiency can be exhibited are determined by appropriate tests in advance for the coil 21 used in the used step-up or step-down circuit 2, the frequency and the pulse width of the coil 21 with which the maximum coil efficiency can be exhibited are confirmed. Then, oscillation means is adjusted so as to be able to always and constantly produce pulse signals having a frequency and/or a pulse width matching with the condition or a value in the vicinity of the frequency and/or the pulse, or an oscillation circuit that can produce pulse signals having such a frequency and/or such a pulse width is selected.

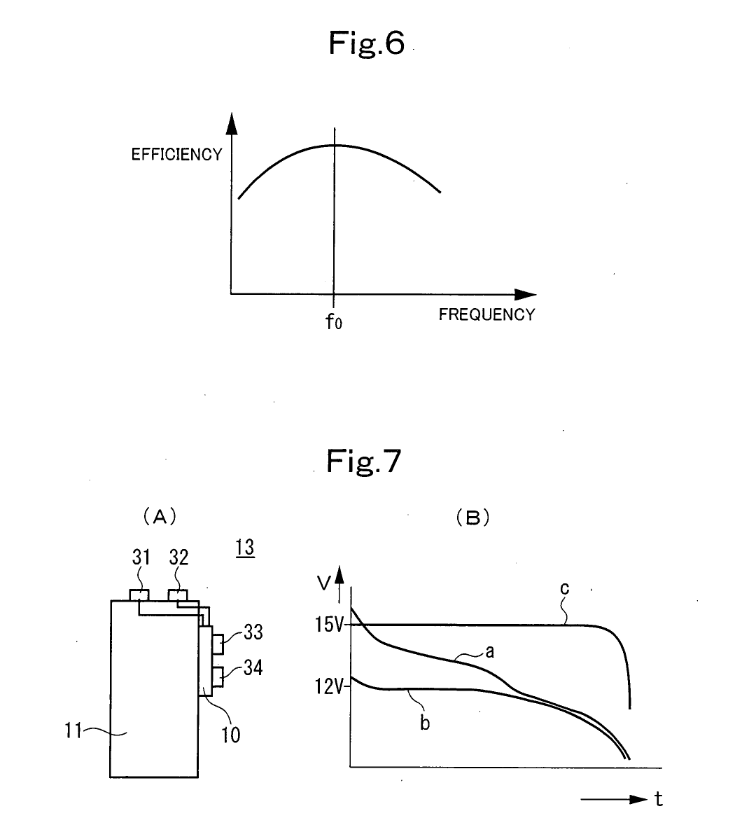

Specifically, for example, when a commercially available appropriate step-up or step-down circuit is obtained, as efficiency for the coil 21 of the step-up or step-down circuit, by taking up outputted power as a characteristic value and monitoring a variation of the outputted power while changing the frequency, a power curve as shown in FIG. 6 can be obtained, a frequency that demonstrate a maximum value in the curve can be selected as a frequency at which the maximum coil efficiency can be exhibited.

It is also possible to perform a similar test for the pulse width or the duty ratio to obtain an optimal value.

The above test is performed for a commercially available step-up or step-down circuit for an electrical torch, with a coil having an inductance of 180 μH. Consequently, as a result of the above test, it is determined that the frequency at which the output power value of the coil exhibits the maximum value is 54.34 kHz.

On the other hand, when the frequency at which the coil efficiency becomes maximum is used as it is, for example, there is a case an optimal power value does not match. In this case, it is desirable to determine the optimal value by varying the duty ratio of the pulse signals (by about 1.5 times to 2 times).

In the above experiment, the duty ratio of the pulse signals is about 17%.

As a result, an oscillation is produced with a frequency of driving pulse signals supplied to the step-up or step-down circuit fixed at 54.34 kHz, and the duty ratio fixed at about 17%.

It is appreciated that, as described above, the frequency can be above or below the frequency of 54.34 kHz by a few %, as long as substantially the same effect can be obtained.

Next, the detecting means 6 according to the present invention is described as follows. The detecting means 6 is configured to detect current or voltage outputted from an output terminal 25 of the step-up or step-down circuit 2, for example, at a point A in FIG. 1, to compare the detected current value or voltage value S0 with a predetermined reference voltage value or reference current value Sref, for example, the reference voltage value Sref of the reference power supply 61 in FIG. 1, to determine whether or not the detected current value or detected voltage value S0 is greater or smaller than the reference value Sref, and, in a case in which the circuit serves as a step-up circuit, to output a detected information signal S1, for example, when the detected voltage value is greater than the reference voltage value 61 (Sref).

Then, the detecting means 6 is designed to keep outputting the detected information signal S1 as long as the detected voltage value or detected current value keeps outputting a value greater than the reference voltage value or reference current value.

When the step-up or step-down circuit 2 is used as the step-down circuit, it should be arranged so that the relation between the reference value and the detected value becomes opposite.

Accordingly, it is possible to use a conventionally known comparator to configure the detecting means 6 according to the present invention.

Further, any configuration can be basically used as the control means 5 used in the present invention, as long as it has a function to control a supply of the pulse signals P1 outputted from the oscillation means 4 to the step-up or step-down circuit 2 based on the detected information signal S1 of the detecting means 6. Specifically, it is necessary that the control means 5 has a function to operate so that the pulse signals P1 outputted from the oscillation means 4 is not supplied to the step-up or step-down circuit 2 based on the detected information signal S1.

More specifically, it is desirable that the control means 5 is configured to keep preventing the pulse signals P1 outputted from the oscillation means 4 from being supplied to the step-up or step-down circuit 2 during a time period in which the detected information signal S1 outputted from the detecting means 6 is maintained. As a result, the pulse signals P1 supplied to the step-up or step-down circuit 2 are intermitted by the control means 5, and accordingly, charge voltage of the capacitor 24 of the step-up or step-down circuit 2 can be maintained at a predetermined value.

As the control means 5 according to the present invention, it is possible to use an arbitrary switching circuit that performs a switching operation in response to an output state of the detected information signal S1.

Further, in the present invention, the duty ratio of the pulse signals P1 outputted from the oscillation means 4 are fixed and always constant, therefore, the pulse frequency is not changed and the duty ratio is constant. Accordingly, the control is easy, the occurrence of ripples is low, the efficiency is maximum, and the adjustment range can be large.

Next, a control method of the constant voltage power supply circuit 10 according to the present invention as described above is described with reference to FIG. 3.

In FIG. 3, the reference voltage value Sref as shown in a graph (a) is inputted to one end of an appropriate comparator that constitutes the detecting means 6, and an output voltage value S0 of the step-up or step-down circuit 2 as shown in a graph (b) is inputted to the other end of the comparator.

As the time passes, the output voltage value S0 of the step-up or step-down circuit 2 increases. At a time t1, when the output voltage value S0 exceeds the reference voltage value Sref, as shown in a graph (c), the detected information signal S1 outputted from the detecting means 6 is in an on state. As a result, an output from a switch of the control circuit 5 becomes an off state as shown in a graph (d). With this, the pulse signals P1 outputted from the oscillation circuit 4 cannot pass the control means 5, and thus the pulse signals P1 supplied to the step-up or step-down circuit 2 are intermitted as shown in a graph (e).

When the output voltage value S0 of the step-up or step-down circuit 2 gradually decreases down to below the reference voltage value Sref at a time t2, the detected information signal S1 becomes the off-state, and such a state continues until the switching means 5 again turned to the off-state.

After that, the above mentioned operation is repeated according to the relation between the reference voltage value Sref and the output voltage value S0 of the step-up or step-down circuit 2.

By such an operation, the output voltage value of the step-up or step-down circuit 2 is maintained stably at a predetermined voltage value.

The following further describes a further embodiment according to the present invention in detail with reference to the drawings.

FIG. 1 is a block diagram showing a configuration of a power supply circuit according to the present invention. In FIG. 1, a numeral 1 indicates a power supply such as a battery, for example, that supplies power to a power supply circuit according to the present invention. A numeral 2 indicates a step-up or step-down circuit for generating a predetermined voltage that is either higher than a voltage of the power supply 1 or lower than a voltage of the power supply 1. A numeral 3 indicates a load of such as an LED driven by the step-up or step-down circuit 2. A numeral 4 indicates a rectangular wave signal oscillation circuit that outputs rectangular wave pulses for switching a switching transistor in the step-up or step-down circuit 2. A numeral 5 indicates a control circuit having a switching function for making the pulse signals of the rectangular wave oscillation circuit 4 be inputted to the step-up or step-down circuit 2, and for preventing the pulse signals from being inputted to the step-up or step-down circuit 2 by intermitting the pulse signal. A numeral 6 indicates a control condition detecting circuit for detecting output voltage of the step-up or step-down circuit 2, and, when the detected voltage is higher than the predetermined voltage 61, for controlling the control circuit 5 to perform the intermittent so that the pulse signals outputted from the rectangular wave signal oscillation circuit 4 is not inputted to the switching transistor of the step-up or step-down circuit 2.

In the power supply circuit thus configured, for example, when the output voltage of the step-up or step-down circuit 2 exceeds the voltage 61, the detecting circuit 6 repeats the intermittent to control the control circuit 5 to be in the off state so that the pulse signals, whose frequency is fixed to a constant value, outputted from the rectangular wave signal oscillation circuit 4 may not be inputted into the switching transistor of the step-up or step-down circuit 2. Accordingly, the output voltage of the step-up or step-down circuit 2 (voltage at the point A in FIG. 1) decreases. Then, when the output voltage of the step-up or step-down circuit 2 is below the predetermined voltage, the detecting circuit 6 controls the control circuit 5 to be the on state, and the pulse signals outputted from the rectangular wave signal oscillation circuit 4 is again inputted into the switching transistor of the step-up or step-down circuit 2 to restart the step-up operation. Therefore, the output voltage of the step-up or step-down circuit 2 starts to increase again.

As described above, in the power supply circuit according to the present invention, when the output voltage of the step-up or step-down circuit 2 is lower than the voltage 61, the pulse signals of the rectangular wave signal oscillation circuit 4 are inputted into the switching transistor of the step-up or step-down circuit 2, the output voltage of the step-up or step-down circuit 2 is increased. When the output voltage of the step-up or step-down circuit 2 is more than the predetermined voltage 61, the pulse signals of the rectangular wave signal oscillation circuit 4 is intermitted so that the pulse signals may not be inputted into the switching transistor of the step-up or step-down circuit 2, thereby maintaining the output voltage of the step-up or step-down circuit 2 always constant.

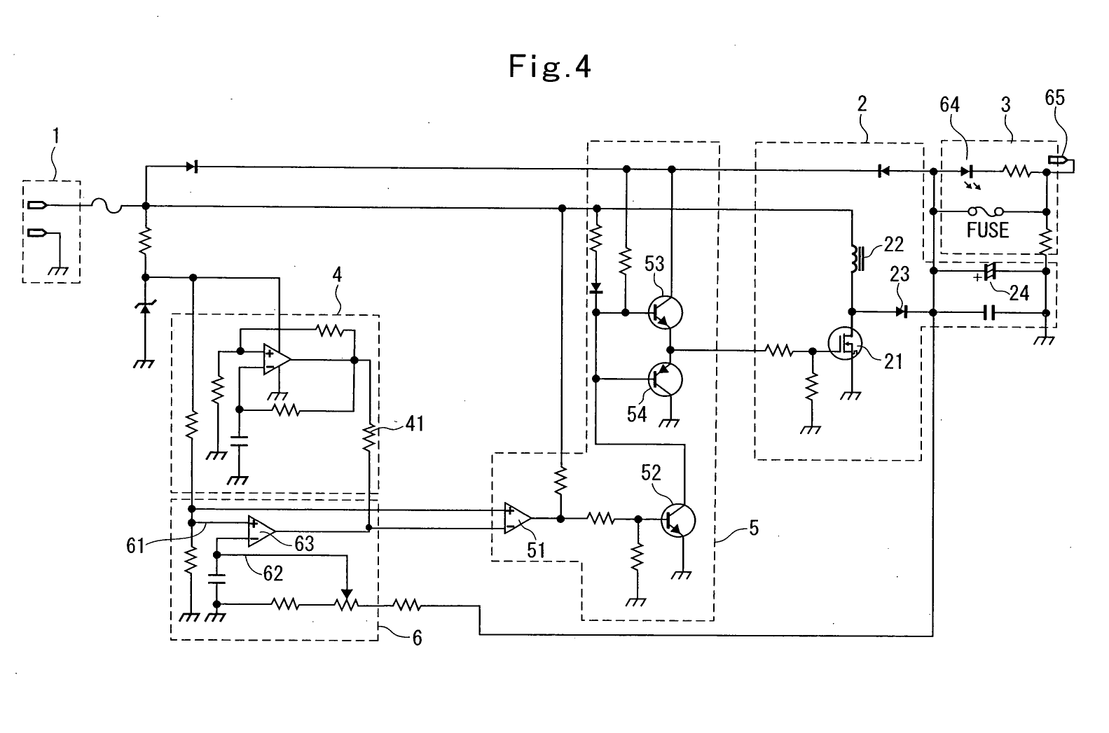

Next, the present invention is described more specifically referring to a circuit diagram shown in FIG. 4.

In FIG. 4, the charge circuit 2 that constitutes the step-up or step-down circuit includes a switching transistor 21, a coil 22 connected serially with the switching transistor 21, a diode 23 connected to a drain of the switching transistor 21, and the capacitor 24 charged via the diode 23. The numeral 4 is a known rectangular wave signal oscillation circuit. The switching circuit 5 includes a comparator 51, a transistor 52 that switches based on an output from the comparator 51, and the transistors 53, 54 that control the switching transistor 21 based on an output from the transistor 52. Further, the switching control circuit 6 includes an open collector comparator 63 that compares the reference voltage 61 with the output voltage of the step-up or step-down circuit 2, and is configured so that the output from the comparator 63 is inputted into the comparator 51 of the switching circuit 5.

In FIG. 4, a numeral 64 is a LED provided for indicating a short at an output terminal, and a numeral 65 indicates the output terminal.

The circuit shown in FIG. 4 operates as in the following manner.

When the output voltage of the step-up or step-down circuit 2 is lower than the reference voltage 61, an output of the comparator 63 is at high impedance. Accordingly, the pulse signals of the rectangular wave signal oscillation circuit 4 are inputted via a resistor 41 into an inverting input terminal of the comparator 51. As a reference voltage is inputted into anon-inverting input terminal of the comparator 51, the inverted pulse signals are outputted as an output of the comparator 51. These pulse signals are inputted into a gate of the switching transistor 21 via the transistors 52 to 53, and the step-up or step-down circuit 2 performs the step-up operation.

Eventually, as the voltage of the capacitor 24 increases by the step-up operation of the step-up or step-down circuit 2 as a charge circuit, the operation proceeds as follows.

When the voltage of the capacitor 24 is higher than the reference voltage 61, an output of the comparator 63 becomes low impedance. Accordingly, an oscillation output of the rectangular wave signal oscillation circuit 4 is grounded via the resistor 41. At the same time, the output of the comparator 51 is at H level, and therefore, the collector of the transistor 52 is at L level, the transistors 53, 54 are turned off, and the switching transistor 21 stops the operation. Therefore, the pulse signals with the frequency fixed at a constant level are intermitted, the step-up operation stops, and the output voltage of the step-up or step-down circuit 2 decreases. Consequently, as described above, the intermittent is interrupted and the step-up operation is performed.

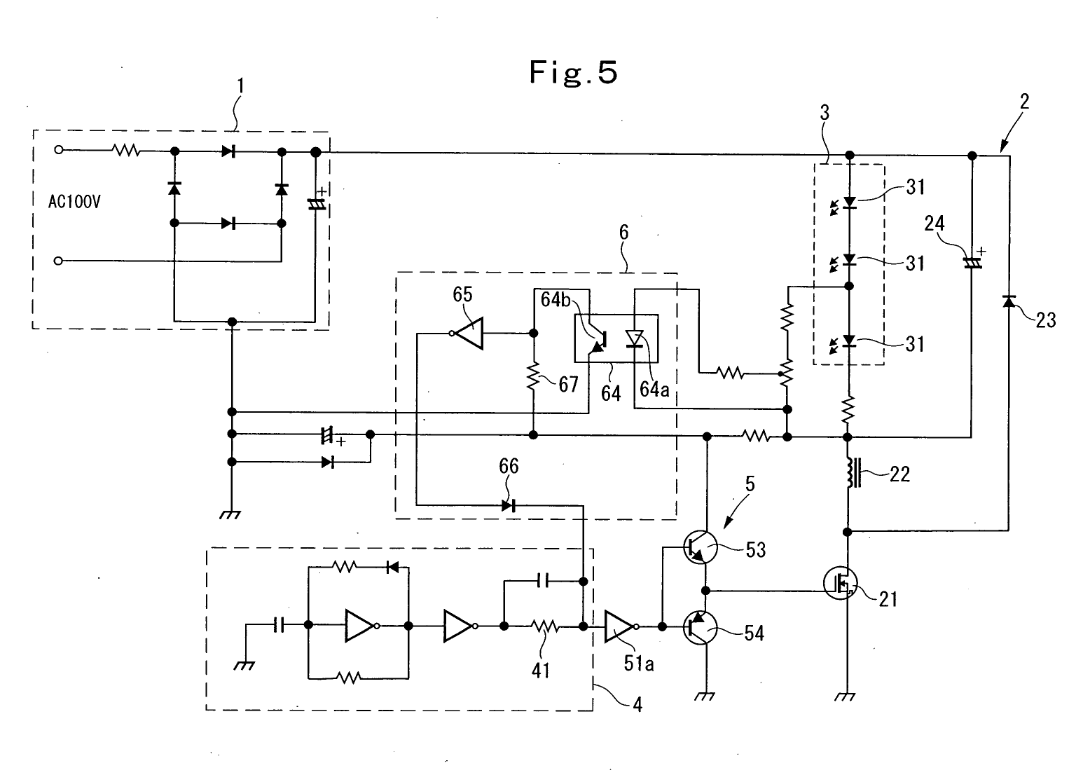

FIG. 5 shows a circuit showing another configuration of the present invention. This circuit is configured so that a power supply of AC 100 V is used to light 12 LEDs 31. Driving voltage of the circuit in which the 12 LEDs are connected serially is about 40 V.

The step-up or step-down circuit 2 is configured to charge the capacitor 24 via the diode 23 by the circuit including the switching transistor 21 and the coil 22 in which the switching transistor 21 is connected serially. The switching circuit 5 is configured in the same manner as in the example shown in FIG. 4.

Further, the switching control circuit 6 includes a photocoupler 64, an inverter 65 connected to the photocoupler 64, and a diode 66 whose anode is connected to an output terminal of the inverter 65. The switching control circuit 6 is configured such that a cathode of the diode 66 is connected to an input terminal of an inverter 51a to detect that charge voltage of the step-up or step-down circuit 2 has reached the predetermined voltage, and to control the switching circuit 5 according to the result of the detection.

In the circuit of FIG. 5 configured as described above, when the charge voltage of the capacitor 24 is lower than the predetermined voltage, the H level is applied to the input of the inverter 65 via the resistor 67. Therefore, an output of the inverter 65 is the L level, and accordingly, the diode 66 is in the off state. Consequently, the pulse signals that are an output from the rectangular wave signal oscillation circuit 4 are inputted into a gate of the switching transistor 21 of the step-up or step-down circuit 2 via the inverter 51a and the transistors 53, 54. Accordingly, a terminal voltage of the capacitor 24 increases.

When the terminal voltage of the capacitor 24 becomes higher than the predetermined voltage, a diode 64a of the photocoupler 64 is turned on, and a transistor 64b of the photocoupler 64 is turned on, and an input of the inverter 65 becomes the L level. Accordingly, an output of the inverter 65 is the H level. Accordingly, as a result that an output of the inverter 51a becomes the L level, the transistors 53, 54 are both in the off state, the operation of the switching transistor 21 stops, and the pulse signals are intermitted, the terminal voltage of the capacitor 24 decreases.

Accordingly, in the circuit shown in FIG. 5, the output voltage of the step-up or step-down circuit 2 is maintained constant.

As described above, because the power supply circuit according to the present invention is configured such that the rectangular wave signals of the predetermined frequency are always inputted to the switching transistor, and the pulse signals are intermitted under a predetermined condition, the noise frequency is constant and does not change, and therefore the noise removal is easy.

Next, another aspect of the present invention is described. A second aspect of the present invention is a constant voltage supplying method using a constant voltage power supply circuit including: oscillation means that produces pulse signals having a predetermined specific frequency; a step-up or step-down circuit that includes at least coil means and capacitive means; detection means that detects an output voltage value of the step-up or step-down circuit; and control means that controls supply operation of the pulse signals outputted from the oscillation means to the step-up or step-down circuit, wherein the method including the steps of: detecting a frequency and/or a pulse width of driving pulse signals at which the coil used for the step-up or step-down circuit exhibits maximum efficiency; setting a oscillation condition under which driving pulse signals of a frequency and/or a pulse width that is the same as or close to the detected specific frequency and/or the pulse width are produced in a fixed manner; driving the step-up or step-down circuit based on driving pulses of the specific frequency and/or a pulse width produced by the oscillation means; causing the detection means continuously to detect a voltage value outputted from the step-up or step-down circuit; causing the detection means to compare the detected output voltage value with a predetermined reference value, and detect a time point either the detected value exceeds the reference value or becomes lower than the reference value to output as detected information; preventing the pulse signals from being supplied to the step-up or step-down circuit by causing the control means to intermit the specific pulse signals outputted from the oscillation means based on the detected information of the detection means; and starting, after the intermittent, supply of the specific pulse signals outputted from the oscillation means to the step-up or step-down circuit when the detected information of the detection means is released.

According to the present invention, various effects as described above can be obtained by performing the above described method.

Next, another aspect of the present invention is explained.

As described above, a basic technical configuration of the constant voltage power supply circuit according to the present invention is such that the output voltage of the predetermined power supply can be easily and accurately stepped up to and stepped down to the predetermined voltage level. At the same time, the constant voltage power supply circuit according to the present invention has such advantages that the amount of the heat generation is small, and that the set step-up voltage or step-down voltage can be maintained constant, and accordingly, a technical field in which the present invention can be applied is extremely wide.

The following describes a specific aspect of the above described constant voltage power supply circuit according to the present invention with reference to the drawings.

FIG. 7(A) shows an example in which the above described constant voltage power supply circuit 10 is applied to an arbitrary battery that is commonly used. In the drawing, a constant voltage power supply battery 13 is illustrated in which the above described constant voltage power supply circuit 10 is brought into contact with a part of a main body of an arbitrary battery 11 via appropriate contacting means or holding means.

The arbitrary battery 11 used in this embodiment is not particularly limited, and it is possible to use conventionally used batteries including lead batteries, nickel cadmium batteries, nickel hydride batteries, lithium ion batteries, alkaline batteries, manganese dioxide batteries, nickel batteries, lithium batteries, zinc batteries, and such.

As shown in FIG. 7(B), output voltages of the above listed conventional batteries respectively show different characteristics depending on the type of the batteries. What is common to all of these batteries is that the voltage decreases as the time passes.

A graph (a) in FIG. 7(B) shows voltage characteristic of a lithium battery, and a graph (b) of FIG. 7(B) shows voltage characteristic of a lead battery.

Conventionally, while some difference can be observed depending on the characteristic of each battery regardless of the type of the battery that is used, the output voltage inevitably declines as the time passes. Therefore, when specific electrical equipment is operated using only a battery as a power supply, the output voltage goes down below the predetermined voltage level when a certain period of time passes, and the electrical equipment cannot exhibit a predetermined function. In this case, it is necessary to exchange the battery or to use another power supply, which is often inconvenient for a user.

In contrast, by using the above described constant voltage power supply circuit 10 according to the present invention along with the conventional arbitrary battery 11, as shown in a graph (c) of FIG. 7(B), the predetermined voltage level that has been previously set can be maintained constantly without being effected by passage of time.

In this embodiment, because the constant voltage power supply circuit 10 according to the present invention can be reduced in size to a desired size, the constant voltage power supply circuit 10 can be attached to a part of an exterior cladding portion of a main body portion of the above described battery 11 using an appropriate attachment means, an adhesion means, or such. It is also possible that the output terminals 31, 32 of the conventional battery and an input terminal of the constant voltage power supply circuit 10 according to the present invention can be electrically connected using an arbitrary connecting means to obtain the predetermined constant voltage from output terminal 33, 34 of the constant voltage power supply circuit 10 easily.

It should be appreciated that, in the present invention, the arbitrary battery 11 and the constant voltage power supply circuit 10 may be only connected using appropriate wiring that connects between the terminals of the arbitrary battery 11 and those of the constant voltage power supply circuit 10 without integrating.

Next, a further different embodiment according to the present invention is described.

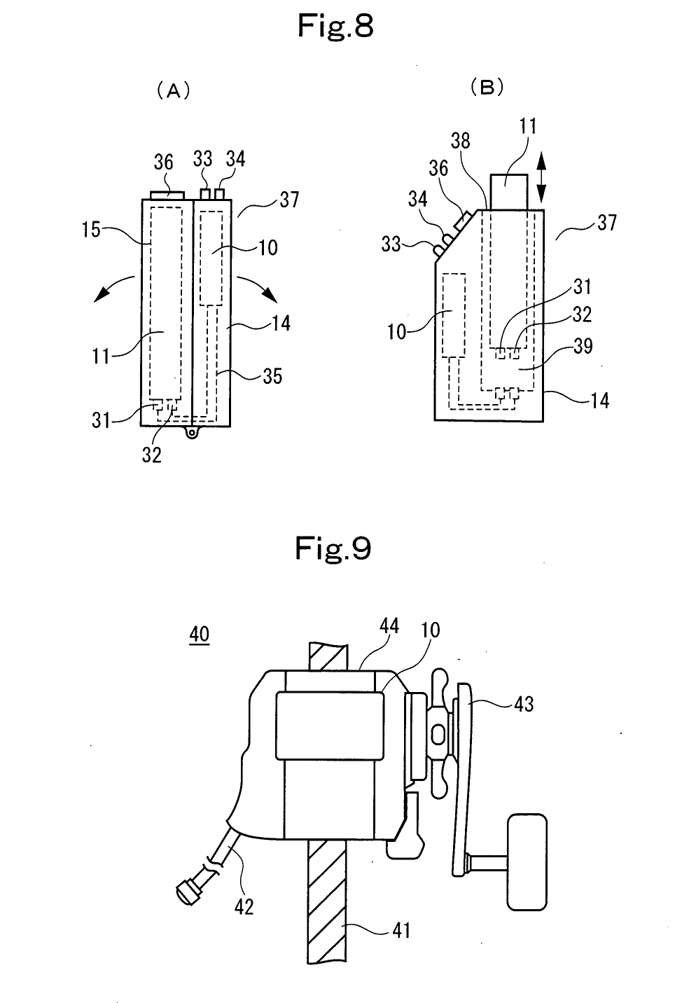

FIG. 8(A) shows a portable constant voltage power supply device 37 having a main body portion 14, the constant voltage power supply circuit 10 according to the present invention that is fixedly disposed inside or outside of the main body portion 14, a battery insertion portion 15 provided to the main body portion 14 and configured so that the arbitrary battery 11 electrically connected with the constant voltage power supply circuit 10 can be freely inserted, a wiring 35 that electrically connects output terminals 31, 32 of the inserted battery 11 with input terminals of the constant voltage power supply circuit 10, the output terminals 33, 34 that is electrically connected with the constant voltage power supply circuit 10 provided for the main body portion 14, and a control panel 36 that controls an output state of the constant voltage power supply circuit 10 and/or displays the state.

In the embodiment according to the present invention as shown in FIG. 8(A), the conventional battery 11 can be detachably and insertably arranged in an appropriate region 15 provided within the main body portion 14.

As one example, as shown in FIG. 8(A), the main body portion 14 may be constituted by a vessel that is split into two portions, and the two portions are configured to be openable and closable using an appropriate engagement means, or to be openable and closable in a semicircle via an appropriate axial structure.

When using, the main body portion 14 is opened, and the above described commercially available battery 11 is inserted at the predetermined position 15, and then the main body portion 14 is closed to use as a constant voltage power supply device 37.

In the embodiment, the output terminals 33, 34 as the constant voltage power supply device 37 are provided at a part of the main body portion 14, and as needed, the control panel 36 may be provided which includes control means with which it is possible to select between using the output voltage of the battery 11 as it is, or operating the constant voltage power supply circuit 10 to use as the constant voltage power supply device 37, or a display means that can display whether or not the constant voltage power supply circuit 10 is operated.

Furthermore, as shown in FIG. 8(B), an appropriate opening 38 may be provided in the predetermined portion of the main body portion 14, the opening 38 may be communicated with a insertion partition portion 39 of the battery 11 provided in the main body portion 14, the predetermined battery 11 is inserted from the opening 38 into the insertion partition portion 39 to be connected to the input terminal of the constant voltage power supply circuit 10 as needed.

With the above described embodiment of the present invention, it is possible to easily obtain a portable constant voltage power supply device, and can be used in a wide range of application as a power supply device used in the mountains and seaside where a fixed power supply terminal cannot be used.

Next, another embodiment according to the present invention is an electric reel 40 using the constant voltage power supply circuit 10 according to the present invention.

Conventionally, the electric reel 40 for fishing that winds a fishing line using a power supply of the battery 11 is commonly used.

Such a conventional electric reel 40 is configured such that predetermined power is directly obtained from a power supply terminal connected to an appropriate battery 11 or a power generating device provided for a fishing boat to drive a motor of the electric reel. There is no problem when it is possible to use the power generating device provided for the fishing boat. However, usually, a fishing person individually carries the battery 11, and the decrease in the voltage is a serious problem when the electric reel 40 is driven by the battery 11 at the fishing point.

Because the output voltage of the battery 11 decreases as the time passes as described above, there is a problem that the voltage of the battery 11 that uses the electric reel 40 for an extended period of time decreases suddenly and the electric reel 40 is not driven when needed. In addition, there is a problem that the fishing person has to carry more than one battery 11 at the same time in order to avoid the above problem.

On the other hand, Japanese Utility Model Application Laid-Open No. H05-91344 discloses an example in which a connection code to which the step-up circuit is connected is connected to an input terminal of the electric reel to drive the electric reel. However, in this known example, only a very basic step-up circuit is shown as the step-up circuit. It is apparent that, with such a step-up circuit, it is not possible to exhibit the step-up or step-down characteristics defined by the present invention, and it is not possible to expect an effect as a constant voltage power supply at all.

In the electric reel 40 according to the present invention, by reducing the size of the above described constant voltage power supply circuit according to the present invention as much as possible, it is possible to directly mount the constant voltage power supply circuit 10 to the main body portion of the electric reel 40.

As shown in FIG. 9, for example, the constant voltage power supply circuit 10 according to the present invention may be attached to a portion of an outer surface of a main body portion 44 of the electric reel 40 attached to an arbitrary fishing rod 41 via appropriate means.

In FIG. 9, a numeral 43 indicates an appropriate handle.

In the present invention, the constant voltage power supply circuit 10 may be arranged within the main body portion 44 that constitutes the electric reel 40. In any case, the input terminal of the constant voltage power supply circuit 10 is desirably connected to a power supply connection code 42 of the electric reel 40 via appropriate connecting means. On the other hand, it is desirable that the output terminal of the constant voltage power supply circuit 10 is directly connected to an input terminal of motor means of the electric reel 40.

In this embodiment, the predetermined step-up voltage or the step-down voltage can be easily obtained regardless of the battery to which the electric reel 40 is connected. In addition, it is possible to serve as a constant voltage power supply device for maintaining the output voltage constantly at the predetermined voltage level, as described above, it is possible to completely avoid a problem that the voltage of the battery is low when needed and the electric reel cannot be driven.

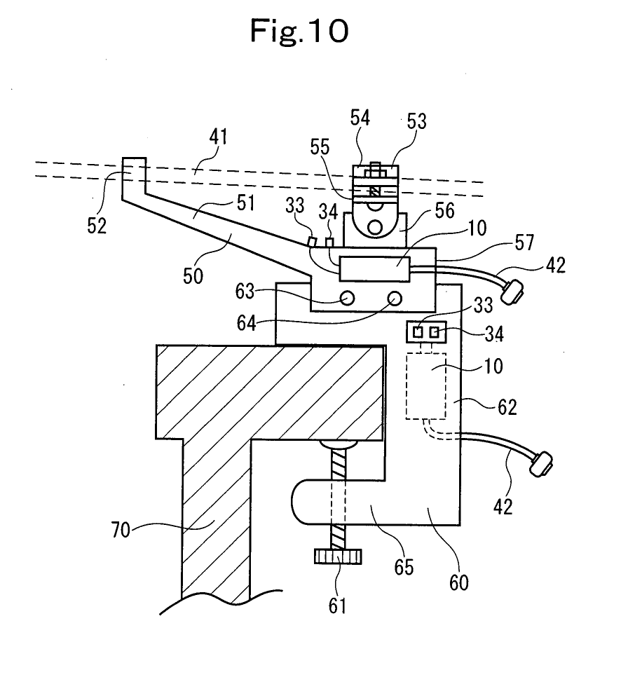

Next, as another embodiment according to the present invention is, as shown in FIG. 10, for example, a fishing rod supporting tool 50 having the constant voltage power supply circuit 10 according to the present invention provided at a part of the main body portion thereof.

In this embodiment, a rod receiving portion 51 in which a fishing rod guiding portion 52 is provided at a tip end portion protruding from a main body portion 57 and a fishing rod fixing portion 53 pivotally attached to a supporting base 56 provided on an upper surface of the main body portion 57 are provided. The fishing rod fixing means 53 is formed by two fishing rod receiving tools 54, 55 that are arranged so that appropriate circular grooves face each other, the fishing rod receiving tools 54, 55 are openable or and closable with an appropriate screw fixing means, and a fishing rod 41 is inserted between the fishing rod receiving tools 54, 55.

In the present invention, the above described constant voltage power supply circuit 10 according to the present invention is provided for a portion of an inner or outer surface of the fishing rod supporting tool 50 using appropriate joining means or engagement means.

In the present invention, by arranging the output terminals 33,34 of the constant voltage power supply circuit 10 on the surface of the fishing rod supporting tool 50, it is possible to easily establish an electrical connection with the electric reel.

Further, the input terminal of the constant voltage power supply circuit 10 according to the present invention may be connected to the predetermined battery or the fixed power supply using an appropriate wiring code 42 and such.

Next, a further different embodiment according to the present invention is a fishing rod holding device 60 having a main body portion 62 with a jaw portion 65 provided at a lower portion of the main body portion 62. As shown in FIG. 10, the fishing rod supporting tool 50 is connected to an upper portion of the main body portion 62 via appropriate attaching devices 63, 64. The fishing rod holding device 60 is fixed to an appropriate boat edge portion 70 via appropriate screw means 61 provided for the jaw portion 65. The constant voltage power supply circuit according to the present invention is provided for a part of the main body portion 62 of the fishing rod holding device 60.

The embodiment is the fishing rod holding device 60 for fixing the fishing rod supporting tool 50 to a predetermined fixing member 70, and the constant voltage power supply circuit 10 according to the present invention is provided for a part of the main body portion 62 of the fishing rod holding device 60.

In this embodiment, it is desirable that the constant voltage power supply circuit 10 is provided for the inner or outer surface of the main body portion 62 of the fishing rod holding device 60.

In this embodiment, by arranging the output terminals 33, 34 of the constant voltage power supply circuit 10 at an appropriate position on the surface of the fishing rod holding device 60, the electrical connection with the electric reel can be easily performed.

The input terminal of the constant voltage power supply circuit 10 according to the present invention is configured to connect to the predetermined battery or the fixed power supply using the appropriate wiring code 42 and such.

With the above described embodiment, the fishing person can enjoy fishing itself for an extended period of time without caring about the decrease in the output voltage of the power supply, and without carrying a number of batteries.

What is claimed is:

1. A constant voltage power supply circuit, comprising:
oscillation means for generating pulse signals having a predetermined specific frequency;
a step-up or step-down circuit including at least coil means and capacitive means;
detection means for detecting an output voltage value of said step-up or step-down circuit, comparing said output voltage value with a predetermined reference value, and outputting a detected information when said output voltage value exceeds said reference value or becomes lower than said reference value; and
control means for controlling, based on said detected information from said detection means, a supply of said pulse signals outputted from said oscillation means to said step-up or step-down circuit,
wherein said control means is configured to prevent said pulse signals from being supplied to said step-up or step-down circuit based on said detected information outputted from said detection means, thereby said control means intermitting said pulse signals outputted from said oscillation means.

2. The constant voltage power supply circuit according to claim 1, wherein said oscillation means is set to generate said pulse signals having a frequency that is the same or close to a frequency at which said coil used in said step-up or step-down circuit exhibits maximum efficiency.

3. The constant voltage power supply circuit according to claim 1, wherein said control means is configured to keep preventing said pulse signals from being supplied to said step-up or step-down circuit while said detected information outputted from said detection means lasts.

4. The constant voltage power supply circuit according to claim 1, wherein said control means is configured so that a period during which said pulse intermitting operation is performed so as to prevent said pulse signals outputted from said oscillation means from being supplied to said step-up or step-down circuit, is changed.

5. A constant voltage power supply circuit, comprising:
a rectangular wave signal oscillation circuit for outputting pulse signals having a predetermined specific frequency;
a step-up or step-down circuit including a switching transistor switching based on said pulse signals, a coil serially connected to said switching transistor, and a capacitor charged by said switching of said switching transistor;
a control circuit for controlling so as either to input said pulse signals from said rectangular wave signal oscillation circuit to said step-up or step-down circuit, or to prevent said pulse signals from being inputted into said step-up or step-down circuit; and
a control condition detecting circuit for detecting an output voltage of said step-up or step-down circuit, and controlling said control circuit so as to prevent said pulse signals from being inputted into said switching transistor when said output voltage of said step-up or step-down circuit is higher or lower than a predetermined voltage value.

6. A control method of a constant voltage power supply circuit comprising:
oscillation means for generating pulse signals having a predetermined specific frequency;
a step-up or step-down circuit including at least coil means and capacitive means;
detection means for detecting an output voltage value of said step-up or step-down circuit; and
control means for controlling a supply operation of said pulse signals outputted from said oscillation means to said step-up or step-down circuit, the method comprising the steps of:
detecting a frequency of said pulse signals at which said coil used for said step-up or step-down circuit exhibits maximum efficiency;
setting an oscillation condition of said oscillation means under which pulse signals having a frequency that is the same as or close to said detected specific frequency are generated in a fixed manner;
driving said step-up or step-down circuit by said pulse signals having said specific frequency generated by said oscillation means;
detecting continuously said output voltage value outputted from said step-up or step-down circuit by said detection means;
comparing said output voltage value with a predetermined reference value by said detection means, and outputting detected information when said output voltage value exceeds said reference value or becomes lower than said reference value;
preventing said pulse signals outputted from said oscillation means from being supplied to said step-up or step-down circuit by said control means, based on said detected information of said detection means; and
starting supply of said pulse signals outputted from the oscillation means to said step-up or step-down circuit by said control means when said detected information of said detection means is released.

7. A constant voltage power supply device for driving an LED light source using the constant voltage power supply circuit according to claim 1.

8. A constant voltage power supply device for driving a motor using the constant voltage power supply circuit according to claim 1.

9. A constant voltage power supply battery, wherein an arbitrary battery is connected to said constant voltage power supply circuit according to claim 1.

10. A portable constant voltage power supply device, comprising:
a main body portion;
said constant voltage power supply circuit according to claim 1 that is fixedly mounted to said main body portion;
a battery holding portion provided within the main body portion and configured so that an arbitrary battery that is electrically connected with said constant voltage power supply circuit is freely insertable or detachable;
output terminals electrically connected with said constant voltage power supply circuit; and
a control panel for controlling and/or displaying an output state of said output terminals.

11. The portable constant voltage power supply device according to claim 10, wherein an opening corresponding to said battery holding portion is provided for a part of said main body portion, an arbitrary battery is freely inserted into said battery holding portion or pulled out from said battery holding portion.

12. An electric reel incorporating said constant voltage power supply circuit according to claim 1.

13. An electric reel, wherein said constant voltage power supply circuit according to claim 1 is fixed on an outer surface of a main body portion of said electric reel.

14. A fishing rod supporting tool having said constant voltage power supply circuit according to claim 1.

15. A fishing rod holding device for fixing a fishing rod supporting tool to a predetermined fixing member, wherein said fishing rod holding device having said constant voltage power supply circuit according to claim 1.

16. The fishing rod holding device according to claim 15, wherein said constant voltage power supply circuit is provided within a main body portion of said fishing rod holding device or on an outer surface of said main body portion of said fishing rod holding device.
